(19) United States
(12) Patent Application Publication
(10) Pub. No.: US 2019/0204582 A1
(43) Pub. Date: Jul. 4, 2019

(54) MEMS-BASED OPTICAL FILTER

(71) Applicant: NOKIA OF AMERICA CORPORATION, Murray Hill, NJ (US)

(72) Inventors: Cristian A. Bolle, Bridgewater, NJ (US); Mark Peter Earnshaw, Berkeley Heights, NJ (US)

(21) Appl. No.: 16/211,738

(22) Filed: Dec. 6, 2018

Related U.S. Application Data
(60) Provisional application No. 62/612,622, filed on Dec. 31, 2017.

(51) Int. Cl. G02B 26/00; G02B 6/293

(52) U.S. Cl. CPC G02B 26/001; G02B 6/2938; G02B 6/29358

(57) ABSTRACT

An apparatus includes a micro-electro-mechanical system (MEMS). The MEMS includes a substrate having electrical lines thereon, a slab of optically transmissive material having parallel opposite partially reflective faces to form an optical etalon, a metal trace rigidly fixed along one or more of the faces of the slab, one or more springs rotatably fixing the slab to the substrate, one more magnets located to produce a magnetic field at the metal trace. The electrical lines are connected to the metal trace to provide an electrical current to the metal trace. The optical etalon is configured to tilt in response to producing an electrical current in the metal trace.

This application claims the benefit of U.S. provisional patent application No. 62/612,622, filed on Dec. 31, 2017, by Cristian A. Bolle, and Mark P. Earnshaw.

### BACKGROUND

### Technical Field

The inventions relate to optical filters, methods of operating optical filters, and systems including optical filters.

### Discussion of the Related Art

This section introduces aspects that may be helpful to facilitating an understanding of the inventions. Accordingly, the statements of this section are to be read in this light and are not to be understood as admissions about what is prior art or what is not prior art.

An optical filter may have a bandpass configuration, for which wavelengths outside of a wavelength passband are substantially attenuated. In a bandpass configuration, an optical filter is typically configured to block or substantially attenuate light having a wavelength outside of a selected range. For example, such an optical filter may be configured to pass light of a selected set of one or more wavelength channels of a wavelength division multiplexed (WDM) system and to block other wavelength channel(s) of the WDM system. Also, the optical filter may have a periodic spectral function that passes wavelengths in a sequence of regularly separated optical passbands.

### BRIEF SUMMARY OF EXEMPLARY EMBODIMENTS

In some embodiments, an apparatus includes a micro-electro-mechanical system (MEMS). The MEMS includes a substrate having electrical lines thereon, a slab of optically transmissive material having parallel opposite partially reflective faces to form an optical etalon, e.g., a type of Fabry-Perot cavity, a metal trace rigidly fixed along one or more of the faces of the slab, one or more springs rotatably fixing the slab to the substrate, one more magnets located to produce a magnetic field at the metal trace. The electrical lines are connected to the metal trace to produce an electrical current in the metal trace. The optical etalon is configured to tilt in response to producing an electrical current in the metal trace.

In some embodiments, the above apparatus may further include collimating optics configured to direct a light beam from a preselected direction towards one face of the slab.

Any of the above apparatus may further include a light intensity detector located to receive light passing through the slab.

Any of the above apparatus may further include collimating optics configured to redirect light exiting one of the faces of the slab in a preselected direction.

In any of the above apparatus, the metal trace may include at least one loop along a surface of the slab.

Some of the above apparatus may further include a mirror located to reflect back light passing through the slab.

Any of the above apparatus may further include a multi-layer reflector located along and near one of the major surfaces of the slab.

Any of the above apparatus may further include an electronic controller configured to selectably control the magnitude of the electrical current. In some such embodiments, the electronic controller may be configured to operate the slab as a wavelength adjustable optical bandpass filter.

In any of the above embodiments, the one or more magnets may include first and second magnets located such that the slab is between the first and second magnets and such that said first and second magnets produce a magnetic field with a substantial component along the surfaces of the slab.

In any of the above apparatus, the one or more springs may include two or more torsion springs.

In second embodiments, a method includes performing an identifying act and a driving act. The identifying act includes identifying an acceptance wavelength channel for a magnetic MEMS type of optical filter having a rotatable optical etalon connected to a substrate by one or more springs. The driving act includes driving an electrical current in a metallic line having a segment rigidly fixed to the optical etalon to cause said optical etalon to rotate such the optical etalon is configured to pass wavelengths of light incident thereon in the acceptance wavelength channel and block wavelengths of said incident light outside the acceptance wavelength channel.

In some of the second embodiments, the identifying and the driving acts may be performed in an optical network unit (ONU), e.g., in an ONU of a passive optical network (PON).

In some of the second embodiments, the identifying and the driving acts may be performed in an optical line termination (OLT), e.g., in an OLT of a PON.

In some of the second embodiments, the driving is such that said optical etalon is subject to a torque due to a magnetic field applied to the segment rigidly fixed to the optical etalon.

### BRIEF DESCRIPTION OF THE DRAWINGS

FIG. 1A is an oblique top view schematically illustrating a single-pass embodiment of an optical filter having a micro-electro-mechanical system (MEMS) for adjustment and/or control of wavelength passband(s);

FIG. 1B is an oblique top view schematically illustrating a double-pass embodiment of an optical filter having a MEMS for adjustment and/or control of wavelength passband(s);

FIG. 2 is an oblique top view illustrating, in more detail, an embodiment of the MEMS optical chip of the optical filters of FIGS. 1A and 1B;

FIG. 3A is a top view illustrating a first specific embodiment of the optical slab of FIGS. 1A, 1B, and 2;

FIG. 3B is a top view schematically illustrating a second specific embodiment of the optical slab of FIGS. 1A, 1B, and 2;

FIG. 4 is a cross-sectional view schematically illustrating an example of the MEMS optical substrate of FIGS. 1A, 1B, 2, 3A, and 3B;

FIG. 5 is a flow chart illustrating an example of a first method of fabricating the MEMS optical chips of FIGS. 1A, 1B, 2, 3A, 3B, and 4;

FIG. 6 is a sequence of cross-sectional views of structures used in the first method of FIG. 5 for fabricating MEMS optical chips of FIGS. 1A, 1B, 2, 3A, 3B, and 4;

FIG. 7 is a flow chart illustrating a method of operating a wavelength-tunable MEMS optical filter, e.g., the optical filters of FIGS. 1A, 1B, 2, 3A, 3B, and 4; and

FIG. 8 is a block diagram schematically illustrating part of a passive optical network (PON) using one or more wavelength-tunable MEMS optical filters of FIGS. 1A and/or 1B.

In the Figures and text, like reference symbols indicate elements with similar or the same function and/or similar or the same structure(s).

In the Figures, relative dimension(s) of some feature(s) may be exaggerated to more clearly illustrate the feature(s) and/or relation(s) to other feature(s) therein.

Herein, various embodiments are described more fully by the Figures and the Detailed Description of Illustrative Embodiments. Nevertheless, the inventions may be embodied in various forms and are not limited to the embodiments described in the Figures and the Detailed Description of Illustrative Embodiments.

### DETAILED DESCRIPTION OF ILLUSTRATIVE EMBODIMENTS

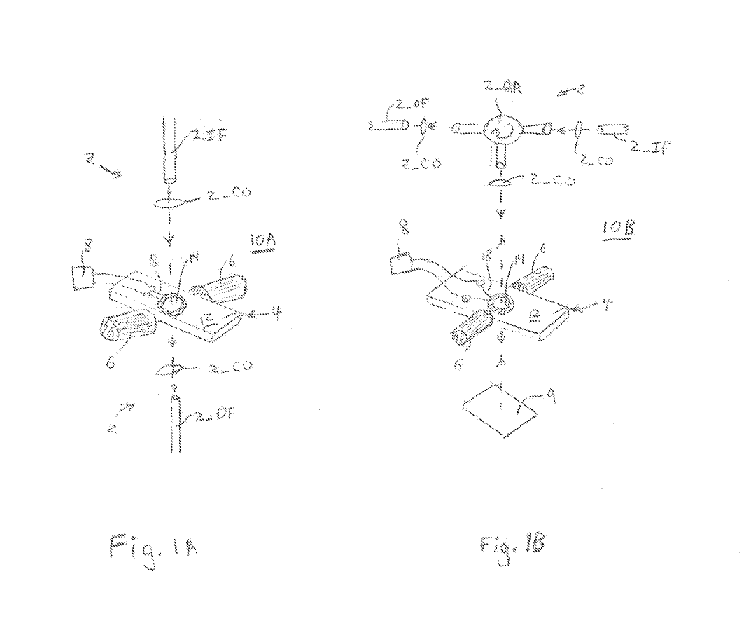

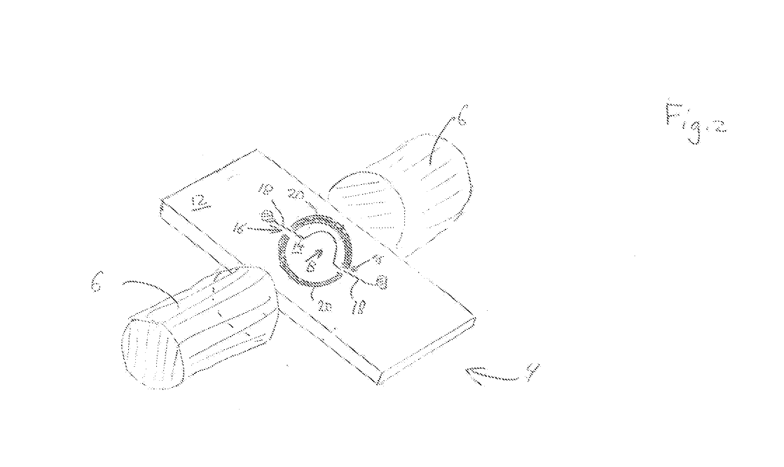

FIGS. 1A and 1B schematically illustrate respective, single-pass and double-pass embodiments 10A, 10B of micro-electro-mechanical system (MEMS) optical filters that are wavelength tunable. The MEMS optical filters 10A, 10B include input/output optics 2, a MEMS optical chip 4, one or more magnets 6, and an electronic controller 8. In FIGS. 1A and 1B, dashed lines with arrows indicate exemplary light rays, which may be present during operation.

Referring to FIG. 1A, the input/output optics 2 of the single-pass optical filter 10A includes an input optical fiber 2_IF and an output optical fiber 2_OF. Optionally, the input and output optical fibers 2_IF, 2_OF may be optically coupled to the MEMS optical chip 4 by optional collimating optics 2_CO, e.g., one or more lenses and/or mirrors.

Referring to FIG. 1B, the input/output optics 2 of the optical filter 10B includes an input optical fiber 2_IF an output optical fiber 2_OF, and an optical rotator 2_OR. The input and output optical fibers 2_IF, 2_OF are coupled to different first and second optical ports of the optical rotator 2_OR, e.g., via optional collimating optics 2_CO; and a third optical port of the optical rotator 2OR is free-space optically coupled to the MEMS optical chip 4, e.g., optionally by collimating optics 2_CO. The various collimating optics 2_CO may include, e.g., one or more lenses and/or mirrors. The optical rotator 2_OR directs light received at the first optical port, from the input optical fiber 2_IF, to the third optical port and directs light, received at the third optical port to the second optical port towards the output optical fiber 2_OF.

Referring to FIG. 1B, the optical filter 10B also includes a mirror 9 that reflects, back to the MEMS optical chip 4, light received from the MEMS optical chip 4 so that said light is filtered via a double pass through the MEMS optical chip 4. After the double pass, the filtered light returns to the same third optical port of the optical rotator 2_OR that directed the light to the MEMS optical chip 4. Said returned light is directed by the optical rotator 2_OR, via the second optical port towards the output optical fiber 2_OF.

Referring to FIGS. 1A and 1B, the electronic controller 8 is connected to adjustably generate an electrical current in metallic line 8 on and/or near the MEMS optical chip 4. The metallic line 8 may include, e.g., one or more metal traces (not shown in FIGS. 1A and 1B) physically fixed to the optical slab 14, e.g., along major surface(s) or interfaces thereof. An optical slab 14 is rotatably connected to a substrate 12 of the MEMS optical chip 4 and has rotation angle with respect to the major surfaces of the MEMS optical chip 4 controlled by the electrical current in the one or more metal traces fixed to the optical slab 4.

The optical slab 14 includes an optical etalon (not shown in FIGS. 1A and 1B) having parallel major surfaces that intersect light rays transmitted between the input and output optical fibers 2_IF, 20F. The angle of optical slab 14 with respect to the substrate 12 determines the angle of incidence of light from the optical input fiber 2_IF on the optical etalon. Thus, the angle of incidence defines the optical path length for said light in the optical etalon and thus, also determines the filtering effect, i.e., wavelength selectivity, of the optical etalon for such light.

The one or more magnets 6 produce a magnetic field at segment(s) of the one or more metal traces fixed to the optical slab 14. Said magnetic field is directionally set to apply a torque to the optical slab 14 in response to a direct current (DC) type of current flowing in the one or more metal traces fixed to the optical slab 14.

The electronic controller 8 is configured to adjust and/or set the wavelength selectivity of MEMS optical filters 10A, 10B by adjusting and/or setting the value of the DC electrical current in the one or more metal traces fixed to the optical slab 14. That is, adjusting and/or setting the value of such an electrical current determines the value of the magnetic torque on the optical slab 14 and determines the stable angle of incidence of light received in the optical etalon of the optical slab 14.

In the MEMS optical filters 10A, 10B, the optical slab 14 and optical etalon therein may be constructed of material(s) approximately transparent to light and/or of low absorption to light in various selected band(s). For operation, the selected band(s) may include portions of the S-band, C-band, and/or L-band of optical communications usage, e.g., for wavelength bands used in optical line terminations (OLT) and/or optical network units (ONUs) of a conventional optical access network such as a passive optical network (PON). The selected band(s) may include portions of the visible light band, e.g., for usage in visible imaging devices and/or may include range(s) of conventional terahertz wavelengths, e.g., for usage in terahertz imaging devices.

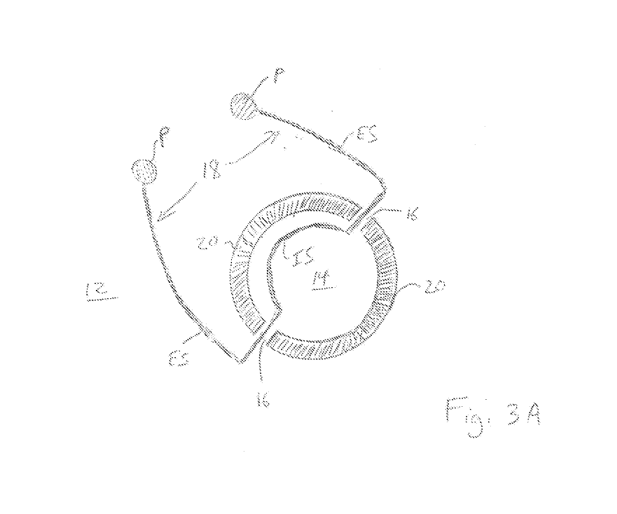

Referring to FIGS. 1A and 1B, various examples of the MEMS optical chip 4 of the optical filters 10A, 10B are described in more detail in FIGS. 2, 3A, 3B, and 4.

Referring to FIGS. 2, 3A, 3B, and 4, the MEMS optical chip 4 is controllable to set the wavelength-selectivity of the optical filters 10A, 10B of FIGS. 1A and 1B, as already mentioned. The MEMS optical chip 4 includes the substrate 12, the optical slab 14, one or more springs 16 (not shown in FIGS. 1A and 1B), and a metallic line 18.

The optical slab 14 includes an optical etalon. The optical etalon has a central layer of optically transmissive material, e.g., transparent material, and about parallel opposite major surfaces. The optical etalon is configured to partially reflect light on or near its parallel opposing major surfaces.

The optical slab 14 may partially reflect light at one or both opposite major face(s) thereof, because one or both major faces have a smooth metal layer thereon, i.e., thereby forming partially reflecting mirror(s).

The optical slab 14 may partially reflect light near one or both major face(s) because, one or both surfaces are near a regular multi-layer of materials of different optical refractive index, e.g., wavelength-selective Bragg partial reflector(s).

The one or more springs 16 physically connect the optical slab 14 to the substrate 12 and provide physical support of the optical slab 14. For example, the one or more springs 16 may support the optical slab 14 in a hole 20 in or through the substrate 12. The one or more springs 16 are configured and connected to enable rotational or tilting movements of the optical slab 14, e.g., in the hole 20. The rotational or tilting movements are typically about a selected axis oriented approximately along the major surface of the optical etalon. For example, the one or more springs 16 may be torsion springs that connect opposite sides of the optical slab 14 to the substrate 12 and thereby define an axis of rotation or tilt of the optical slab 14. Such an axis is typically approximately located in the plane of the substrate 12, e.g., close to a major surface of the substrate 12.

The one or more springs 16 may be torsion springs of forms used in conventional micro-electromechanical system (MEMS) with a tilting component. Such torsion springs may be, e.g., fabricated of silicon, e.g., amorphous or poly-crystalline silicon, metal, and/or a combination of silicon and metal. Such torsion springs may have various geometrical shapes, e.g., a flat zig-zag shape or a bar shape, may have different cross-sectional shapes, and may include one or more separately twistable component springs. Constructing such torsion springs, for the MEMS optical chip 4, would be straightforward for persons of ordinary skill in fabricating MEMS devices in light the teachings of the present disclosure.

The metallic line 18 typically includes metal traces, which are connected to carry an electrical current during operation, i.e., a current generated by the electronic controller 8 of FIGS. 1A and 1B. The one or more segments of the metallic line 18 are located and attached such that a magnetic field B produced by the one or more magnets 6 can produce a torque on the optical slab 14, e.g., to produce tilting or rotational movement thereof. The magnetic field B can produce a torque on the optical slab 14 that is typically opposed by a torque caused by the one or more springs 16.

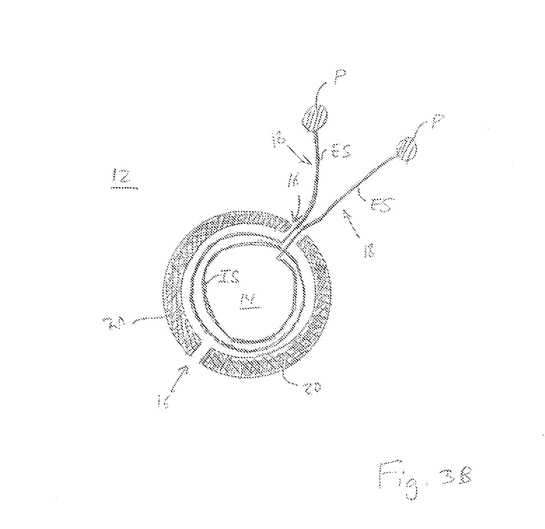

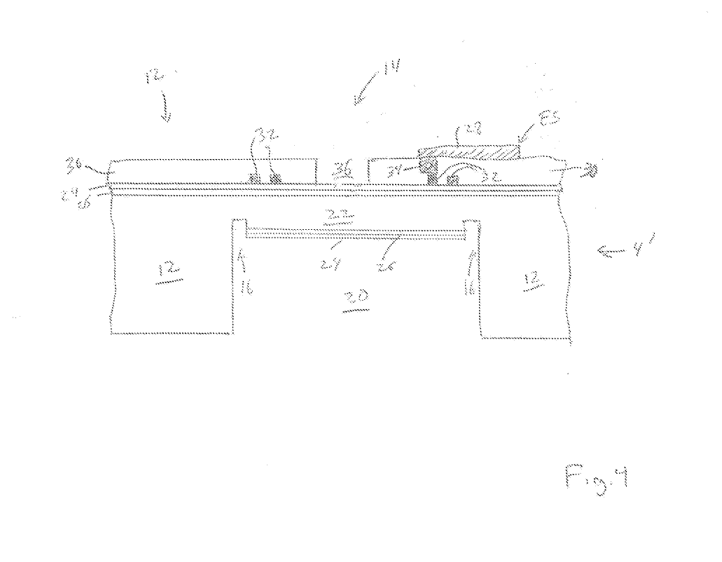

The metallic line 18 typically has an interior segment IS, e.g., having sub-segments located along one or both major surfaces of the optical slab 14 or optical etalon therein, and external segments ES located on, along, and/or near the major surface(s) of the substrate 12. The sub-segments of the interior segment IS are physically attached to the optical slab 14 so that magnetic forces thereon are transferred to the optical slab 14. Along the major surface(s) of the optical slab 14, the segment of the metallic line 18 may have a variety of alternate shapes as illustrated, e.g., by the metal traces in FIGS. 3A and 3B. Typically, the metallic line 18 does not cover an area of the optical slab 14, e.g., a central area, through which light interacts with the optical etalon thereof.

FIG. 3A illustrates embodiments of the MEMS optical chip 4 of FIG. 2 in which the interior segment IS of the metallic line 18 has a form of a regular or irregular arc shaped metal trace on one major surface of the optical slab 14. For example, the arc may be located primarily on one side of the axis of tilt or rotational motion of the optical slab 14. The two ends of the interior segment IS may end-connect to the external segments ES of the metallic line 18, e.g., by metal traces over the one or more springs 16. The external segments ES are located on, along, and/or near one major surface of the substrate 12 and, e.g., may electrically connect to metallic pads P on said major surface of the substrate 12. The metallic pads P may provide points for electrical connections between the metallic line 18 and electrical lines from the electronic controller 8 of FIGS. 1A-1B, i.e., so that the electronic controller 8 can drive various currents through the metallic line 18.

FIG. 3B schematically illustrates alternate embodiments of the MEMS optical chip 4 of FIG. 2 in which the metallic line 18 has one or more regular or irregular loop shaped metal traces on one major surface of the optical slab 14. Here, the metallic line 18 may cross the tilting or rotation axis of the optical slab 14 one or more times. The ends of the interior segment IS again end-connect to external segments ES of the metallic line 18, e.g., via metal traces over the one or more springs 16. Again, the external segments ES are located on, along, and/or near one of the major surfaces of the substrate 12 and, e.g., may electrically connect to metallic pads P that provide electrical connection points for the electronic controller 8 of FIGS. 1A-1B, i.e., so that the electronic controller 8 can drive various currents through the metallic line 18.

In FIGS. 3A-3B, any apparent crossings of the metallic line 18 are electrically insulated to avoid electrical shorting thereof. For example, the illustrated crossing of the interior segment IS of the metallic line 18 of FIG. 3B is a crossing of a line of metallization layer with a line of the coil, which are typically fabricated in different layers of the optical slab 14 to avoid electrical shorting.

Referring to FIGS. 1A, 1B, and 2, the one or more magnets 6 are located to apply a magnetic field B across a sub-segment of the interior segment IS of the metallic line 18, which is located on the one or more major surfaces the optical slab 14. The one or more magnets 6 may be conventional permanent magnet(s) and/or electromagnet(s).

Referring to FIG. 2, the one or more magnets 6 are configured, e.g., oriented, to produce a magnetic field B that can causes a torque on the optical slab 14 when major surfaces of said optical slab 14 and the substrate 12 are approximately parallel and a DC current is flowing in the metallic line 18. For example, the illustrated magnetic field B has a large component in the plane of the major surface of the optical slab 14, when the major surfaces of the optical slab 14 and the substrate 12 are about parallel. Such a magnetic field B may also be substantially transverse to sub-segment(s) of the interior segment IS of the metallic line 18 distant from and approximately parallel to the tilting/rotation axis of the optical slab 14. For this reason, the magnetic field B can apply a torque favoring a tilting or rotational movement of the optical slab 14 away from a major surface of the substrate 12, i.e., at least for small relative tilt or rotational angles when the metallic line 18 carries a DC current.

Referring again to FIGS. 1A and 1B, the electronic controller 8 is adjustable to produce various selected currents to flow through the metallic line 18. In particular, the electronic controller 8 sets the DC components of such currents to produce a torque on the optical slab 14. The electronic controller 8 sets the final tilt or rotational angle of the optical slab 14 based on the sum of the torque, caused by the magnetic field B of the one or more magnets 6, and the torque caused by the one or more (torsion) springs 16 vanishing.

FIG. 4 illustrates a specific embodiment 4′ of the MEMS optical chip 4 of FIGS. 1A, 1B, and 3B. Specific embodiments of the MEMS optical chips 4 of FIGS. 2 and 3A would have similar structures with modification to the interior segment IS of the metallic line 8 in FIG. 4.

The MEMS optical chip 4′ includes an optical etalon formed by a central silicon layer 22 and partial Bragg reflectors on both major surfaces of the central silicon layer 22. Each partial Bragg reflector is formed by one or more pairs of silicon dioxide (i.e., silica glass) and silicon layers 26, 24. For such an optical etalon, the free spectral range is approximately given by: FSR=λ²/(2Ln). Here, λ is the central wavelength of the relevant light, L is the thickness of the etalon, i.e., approximately the thickness of the central silicon layer 22, and n is the refractive index of said central silicon layer 22 of the etalon.

Similar silicon cavity type of optical etalons may be advantageously used the optical slabs 14 of any of FIGS. 1A-1B, 2, 3A-3B, and 4. In particular, the high refractive index of the central silicon layer 22 and the high index contrast between silicon dioxide and silicon layers 24, 26 typically enables an optical etalon with a silicon cavity to be thinner than an optical etalon with a silica glass cavity. Since silicon has a much higher refractive index than silica glass, a physically thinner central silicon layer corresponds to the same optical path length as a much thicker central silica glass layer. The dynamical angular alignment of an optical slab 14 to select a new passband wavelength may be performable more rapidly when the optical slab 14 is lighter, e.g., due to the presence of a much thinner optical etalon.

As an example, the inventors believe that the optical etalon of FIG. 4 may be constructed to provide for suitable bandpass filtering of about 4 wavelength channels of about 100 giga-Hertz width near a wavelength of about 1599 nm. For example, each partial Bragg reflector may have a single pair of silica and silicon layers 26, 24, wherein the silica layer 26 has a thickness of about 277 nanometers (nm) and a refractive index of about 1.44 and the silicon layer 24 has a thickness of about 82 nm and a refractive index of about 4.89. Finally, for a desired set of wavelength passbands, the thickness of the central silicon layer 22, i.e., the optical cavity of the optical etalon, may be found from the above formula.

FIG. 4 also schematically illustrates an electrical connection structure of the interior segment IS of the optical slab 14 and the one or more springs 16 of FIG. 3B. The electrical connection structure includes a patterned metallization layer 28 located on an insulating layer 30, e.g., a conventional dielectric, which covers the metal traces 32 of the interior segment IS. The metallization layer 28 may connect to the metal traces, e.g., the loops illustrated in FIG. 3B, via metallic plugs 34, and may connect to the exterior segments ES of metallic lines 8, which are located on the substrate 12, via short metallic segments located over the one or more springs 16.

The MEMS optical chip 4′ may also include a window 36 that enables external light to interact with the optical etalon without propagating through the insulation layer 30.

Based on the present disclosure, persons of ordinary skill in the relevant art, would be able to determine suitable layer thicknesses and compositions of such optical slabs 4′ and variations thereto without a need for undue experimentation.

The MEMS optical chip 4 of FIGS. 1A, 1B, 2, 3A, 3B, and 4 can be fabricated by various methods.

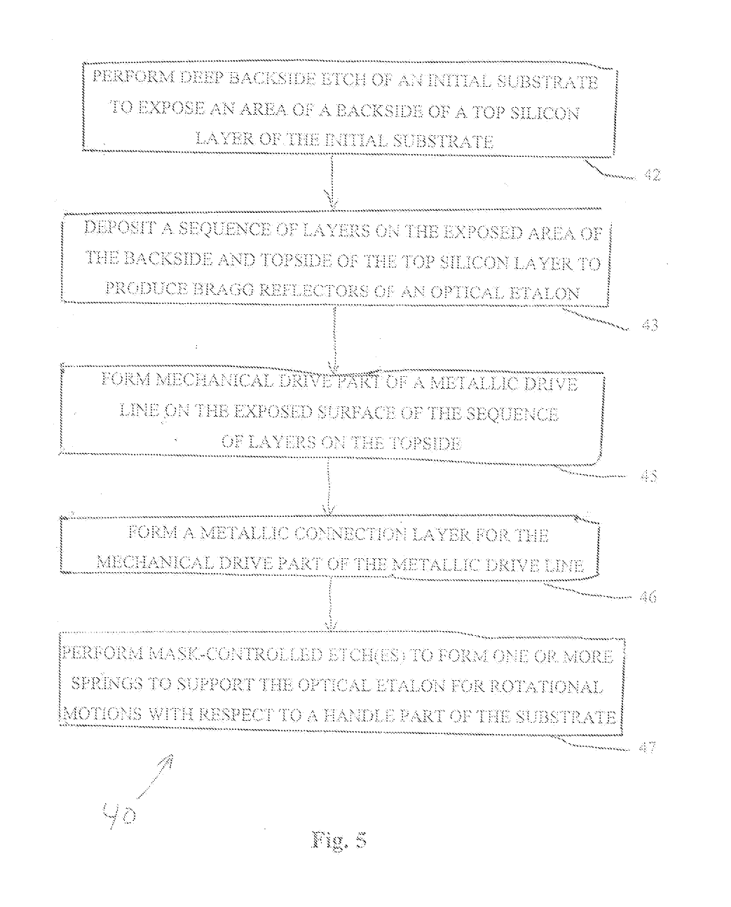

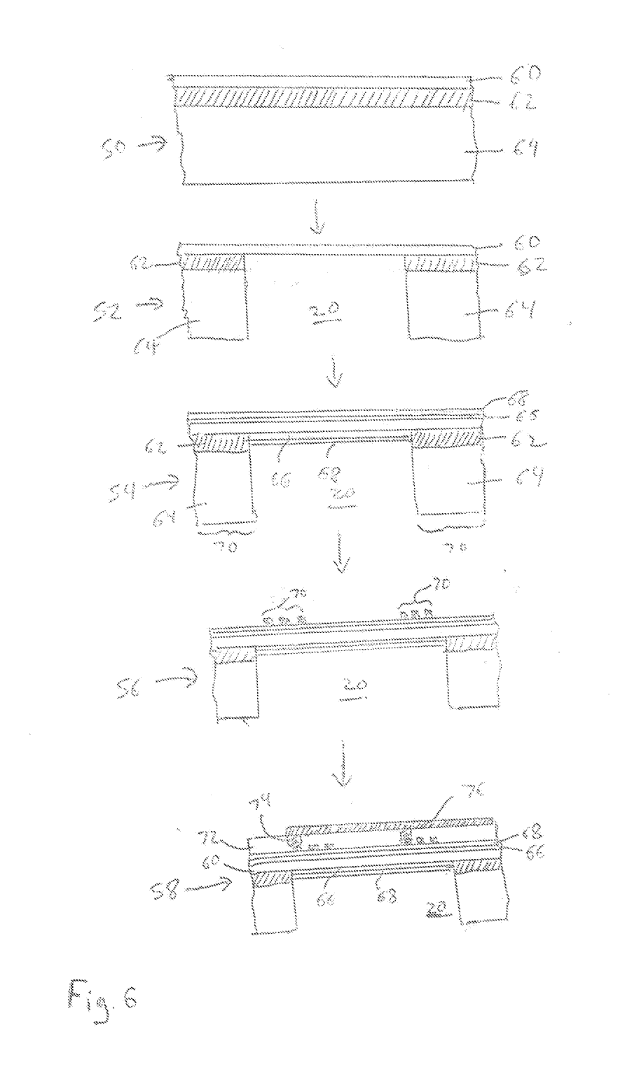

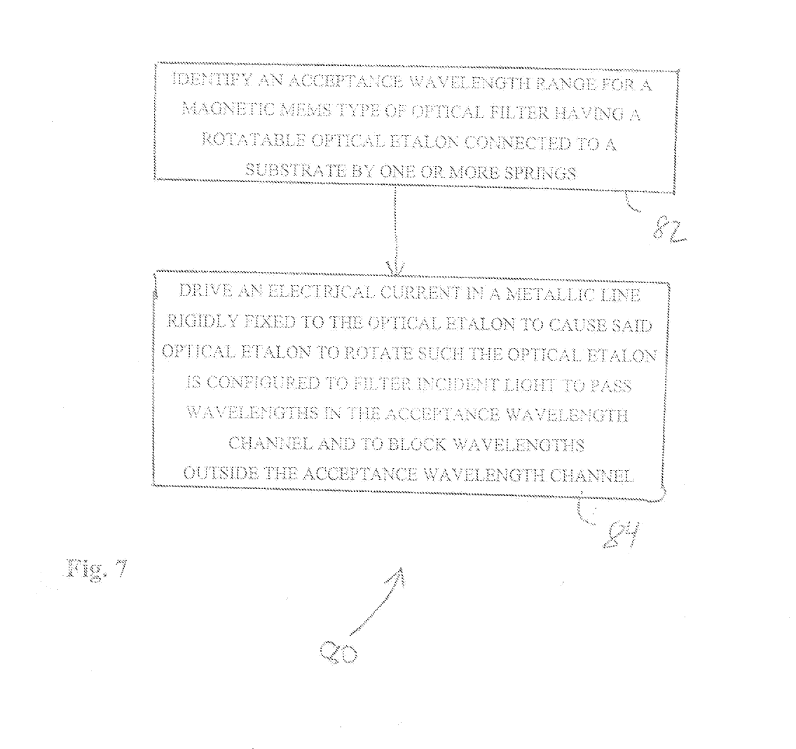

A first method 40 is schematically illustrated in FIG. 5 and provides structures 50, 52, 54, 56, 58, as schematically illustrated in FIG. 6. The first method 40 involves forming the MEMS structure 4 from a multi-layer initial substrate 50. The initial substrate 50 may be, e.g., a commercially available silicon on insulator (SOI) wafer substrate, i.e., silicon-on-silica glass on a silicon wafer substrate. For the initial substrate 50, the top layer 60 may be a silicon layer, middle layer 62 may be a silica glass or silicon dioxide layer and the substrate 64 may be a silicon wafer substrate, as schematically illustrated in FIG. 6.

The first method 40 includes performing deep backside etch of the initial substrate 50 to expose an area of the backside of the top silicon layer 60 of the initial substrate 50 thereby producing the intermediate structure 52 of FIG. 6 (step 42). The backside exposed part of the silicon layer 60 will provide the central layer of the optical etalon in the optical slab 14 and part of the hole 20 of FIGS. 1A, 1B, 2, 3A, 3B, and 4. The thicker unetched portion 70 of the initial substrate 50 provides a mechanical handle. In the step 42, the deep etch may be performed, e.g., using the conventional Bosch deep etch process to remove part of the silicon wafer substrate 64 and a reactive ion etch to remove part of the silica layer 62. Both processes are well known in micro-electronics fabrication.

The first method 40 includes depositing a sequence of thin layers on the exposed area of the backside and topside of the top silicon layer 60 to produce partial Bragg reflectors on opposing major surfaces thereof and to form the intermediate structure 54 of FIG. 6 (step 43). Each sequence typically includes one or more layer pairs, wherein each layer pair is formed by a silica layer 66 and a silicon layer 68. Each sequence of layer pairs 66, 68 will provide a partially reflective Bragg grating for the optical etalon of the optical slab 14 of FIGS. 1A, 1B, 2, 3A, 3B, and 4. The deposition step 43 may be performed using conventional processes for micro-electronics fabrication.

The first method 40 includes forming a mechanical drive part 71 of the interior segment IS of the metallic line 18 of FIGS. 2, 3A, 3B, and 4 on the exposed surface of the top sequence of one or more layer pairs on the topside thereby producing intermediate structure 56 (step 45). The formed mechanical drive part 71 of the interior segment IS may be an arc-shaped or a coil-shaped metal trace and is rigidly attached to adjacent portions of the top surface near the edge of the backside etched hole in the structure 56, as schematically illustrated in FIGS. 2-3A and 3B. The forming step 45 may use a conventional mask-controlled metal deposition process or a conventional blanket metal deposition and a conventional controlled metal etch process, e.g., an ion etch. The mechanical drive part 71 of the metallic line 18 can be formed of a variety of high conductance metals, e.g., gold, aluminum, silver, copper or alloys and/or multilayers of such metals.

The first method 40 includes forming a metallic electrical connection layer for the mechanical drive part 71 of the interior segment IS, of metallic line 18 of FIGS. 1A, 1B, 2, 3A, 3B, and 4, on the structure 56 thereby producing the structure 58 of FIG. 6 (step 46). The forming step 46 involves the sub-steps of depositing a dielectric passivation layer 72 on the top surface of the intermediate substrate 56; etching holes therein to the ends of the metal trace of the previously formed mechanical drive part 71; filling said holes with metallic plugs 74, e.g., tungsten or a multi-metal layered plugs, and forming metallic wiring lines 76 on the passivation dielectric layer 72 to connect the interior segment IS of the metallic line 18 and to the exterior segment ES of the metallic line 18 as illustrated in FIGS. 1A, 1B, 2, 3A, 3B, and 4. The passivation dielectric layer 72 is an electrical insulator that may, e.g., have a different composition than silica glass, e.g., silicon oxy-nitride or silicon nitride. The metallic wiring lines 76 can be formed of a variety of high conductance metals, e.g., gold, aluminum, silver, copper or alloys and/or multilayers of such metals.

The first method 40 also includes performing one or more mask-controlled etches of the structure 58 to form one or more springs to support the optical etalon suitably to enable rotational motions thereof with respect to a thicker handle part 70 of the substrate (step 47). The one or more mask-controlled etchings form the one or more springs 16 of FIGS. 2, 3A, 3B, and 4 and release the optical slab 14 of FIGS. 1A, 1B, 2, 3A, 3B, and 4 to enable tilt or rotational motions thereof. The mask-controlled etch step 47 may optionally include etching away a portion of the passivation dielectric layer 72 over a central area of the final optical slab 14, i.e., to form widow 36 of FIG. 4, thereby enabling unobstructed light access to the optical etalon therein. The mask-controlled etch step 47 may use various conventional mask and isotropic and/or anisotropic etch processes of micro-electronics fabrication.

In a second method, the optical etalon of the optical slab 14 of FIGS. 1A, 1B, 2, 3A, 3B, and 4 may be constructed separately and then glued to the substrate 12. Conventional microelectronics fabrication processes may be used to form the optical slab 14. The processes may include, e.g., forming a series of one or more pairs of silica and silicon layers on both major surfaces of a silicon slab of suitable thickness thereby producing an optical etalon with partially reflective mirrors in a selected wavelength range. Before or after the optical etalon is glued to the substrate, the second method includes forming the one or more springs 16 and the metallic line 18, e.g., using processes and/or steps similar to those of the first method 40 as already described.

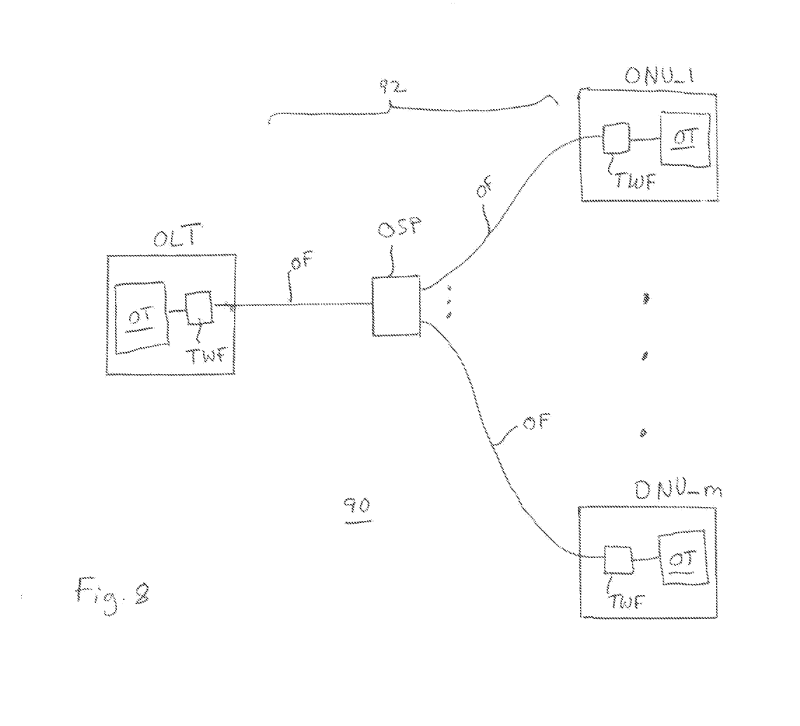

FIG. 7 illustrates a method 80 of operating a magnetic MEMS-type of wavelength-tunable MEMS optical filter, e.g., the optical filters 10A, 10B of FIGS. 1A and 1B. The wavelength-tunable MEMS optical filter has a rotatable optical etalon connected to a substrate by one or more springs, e.g., as in the optical filters 10A, 10B of FIGS. 1A and 1B as shown in FIGS. 2, 3A-3B, and 4.

The method 80 includes identifying an acceptance wavelength channel for the magnetic MEMS type of wavelength-tunable MEMS optical filter (step 82). For example, the identifying step 82 may involve looking up the wavelength range of the acceptance wavelength channel in a digital data storage or receiving a data message identifying said wavelength range. The identified wavelength channel may be, e.g., a wavelength channel assigned for transmission or reception during a corresponding time slot of an optical network, e.g., during a transmission or reception time slot for a time-division-multiplexed optical network such as a passive optical network (PON).

The method 80 includes driving an electrical current in a metal trace rigidly physically fixed to the rotatable optical etalon to cause said optical etalon to rotate such that the optical etalon is configured to pass wavelengths of light incident thereon in the acceptance wavelength channel and to block or substantially attenuate wavelengths of said incident light outside the acceptance wavelength channel (step 84). For example, a wavelength channel adjacent to the acceptance wavelength channel may be attenuated by 3 or more decibels. Typically, the driving act is such that said optical etalon is subject to a torque due to a magnetic field applied to the segment of the metallic line rigidly physically fixed to the optical etalon, i.e., when said line has a current therein.

In some embodiments, the method 80 may be performed in an ONU and/or an OLT, e.g., in a PON, to dynamically perform wavelength channel selection for the optical transceiver therein.

As previously described, the optical slab 14 of FIGS. 1A, 1B, 2, 3A, 3B, and 4 takes an equilibrium angular orientation with respect to the substrate 12 as defined by the DC current in the metallic line 18. But, the transient time to reach said equilibrium orientation may depend on the process used to tilt or rotate the optical slab 14. In particular, suddenly performing driving act 84 of the method 80 with a desired final DC current to the metallic line 18 as a single step operation may cause the optical slab 14 to undergo oscillatory rotations with slow damping thereof. Thus, such a simple application of the transient DC driving current may increase the time needed to set a new optical passband wavelength for the optical filters 10A and 10B of FIGS. 1A and 1B.

The inventors believe that such undesired oscillations of the optical slab 14 may be more quickly damped when the electronic controller 8 of FIGS. 1A and 1B changes the applied driving current via a two-step electrical transient driving waveform, e.g., in the driving act 84 of the method 80 of FIG. 7. Relevant transient driving waveforms may be disclosed in the article: “Input shaping and time-optimal control of flexible structures,” by M. A. Lau and L. Y. Pao, which is published in Automatica, vol. 39, no. 5, pp. 893-900, May 2003. This article is incorporated by reference herein, in its entirety. The inventors believe that such a 2-step transient waveform for which a ratio of the two transient current amplitudes of the waveform are close to 0.5 and a delay of the second step of the transient waveform is about ½ of the oscillation period of the optical slab 14 may help to provide rapid damping of oscillations of the optical slab 14 of FIGS. 1A, 1B, 2, 3A, 3B, and 4.

Based on the present disclosure, the inventors believe that the person of ordinary skill could easily determine the forms of suitable electrical driving waveforms for the electronic controller 8 of FIGS. 1A and 1B for various embodiments of the optical filters 10A and 10B.

FIG. 8 illustrates a PON 90 that incorporates the magnetic MEMS optical filter(s) 10A, 10B of FIG. 1A and/or FIG. 1B. The PON 90 includes an optical line termination (OLT) and m optical network units (ONUs) ONU_1, . . . , ONU_m, which are optically connected by a passive optical fiber network 92. The passive optical fiber network 92 includes optical fibers OF and one or more passive optical splitters OSP. The passive optical fiber network 92 can have many different topologies.

In various embodiments, the PON 90 is configured to assign different wavelengths for upstream and downstream traffic and/or to assign different wavelengths to ONUs in a time dynamic manner. For example, the assigned wavelength channel may change with time slot in a time division multiplexing (TDM) protocol and/or may change between TDM time slots for upstream and downstream transmission. For this reason, some or all of the ONUs ONU_1 . . . ONU_m and/or the OLT support time-dependent wavelength selectivity. In particular, the ONUs and the OLT typically include an optical transceiver OT and a tunable wavelength-selective filter TWF.

In the PON 90, some or all of the TWFs of the ONUs ONU_1 . . . ONU_m may include the wavelength tunable optical filter 10A, 10B of FIGS. 1A and/or 1B and/or the TWF of the OLT may be one of the wavelength tunable optical filters 10A, 10B of FIGS. 1A and/or 1B. Due to the use of the optical filter(s) 10A, 10B of FIGS. 1A and/or 1B, those of the TWFs may be manufactured less inexpensively, e.g., often a big advantage for an ONU, and/or may provide for faster wavelength switching.

From the disclosure, drawings, and claims, other embodiments of the invention will be apparent to those skilled in the art.

What is claimed is:

1. An apparatus, comprising a micro-electro-mechanical system further comprising:
a substrate having electrical lines thereon;
a slab of optically transmissive material having parallel opposite partially reflective faces to form an optical etalon;
a metal trace being rigidly fixed along one or more of the faces of the slab;
one or more springs rotatably fixing the slab to the substrate;
one more magnets located to produce a magnetic field at the metal trace; and
wherein the electrical lines are connected to the metal trace to provide an electrical current to the metal trace; and
wherein the optical etalon is configured to tilt in response to producing an electrical current in the metal trace.

2. The apparatus of claim 1, further comprising collimating optics configured to direct a light beam from a preselected direction towards one face of the slab.

3. The apparatus of claim 2, further comprising a light intensity detector located to receive light passing through the slab.

4. The apparatus of claim 3, further comprising collimating optics configured to redirect a light exiting one of the faces of the slab in a preselected direction.

5. The apparatus of claim 1, wherein the metal trace includes at least one loop along a surface of the slab.

6. The apparatus of claim 1, further comprising a light intensity detector located to receive light passing through the slab.

7. The apparatus of claim 1, further comprising a multi-layer reflector located along and near one of the major surfaces of the slab.

8. The apparatus of claim 7, wherein the metal trace includes at least one loop along a surface of the slab.

9. The apparatus of claim 1, further comprising an electronic controller configured to selectably control the magnitude of the electrical current.

10. The apparatus of claim 9, wherein the controller is configured to operate the slab as a wavelength adjustable optical bandpass filter.

11. The apparatus of claim 1, wherein the one or more magnets includes first and second magnets located such that the slab is between the first and second magnets and such that said first and second magnets produce a magnetic field with a substantial component along the surfaces of the slab.

12. The apparatus of claim 1, wherein the one or more springs include two or more torsion springs.

13. A method, comprising:
identifying an acceptance wavelength channel for a magnetic MEMS type of optical filter having a rotatable optical etalon connected to a substrate by one or more springs; and
driving an electrical current in a metallic line having a segment rigidly fixed to the optical etalon to cause said optical etalon to rotate such that the optical etalon is configured to pass wavelengths of light incident thereon in the acceptance wavelength channel and to attenuate wavelengths of said incident light outside the acceptance wavelength channel.

14. The method of claim 13, wherein the identifying and the driving are performed in an ONU.

15. The method of claim 13, wherein the identifying and the driving are performed in an OLT.

16. The method of claim 13, wherein the driving is such that said optical etalon is subject to a torque due to a magnetic field applied to the segment rigidly fixed to the optical etalon.
